(19) United States
(12) Patent Application Publication
(10) Pub. No.: US 2003/0197122 A1
(43) Pub. Date: Oct. 23, 2003

(54) System and method for tracking germ contamination

(76) Inventors: Norman A. Faiola, Ithaca, NY (US); Jack J. Kennamer, Maineville, OH (US)

Correspondence Address: WOOD, HERRON & EVANS, LLP, 2700 CAREW TOWER, 441 VINE STREET, CINCINNATI, OH, 45202, US

(21) Appl. No.: 10/352,741

(22) Filed: Jan. 28, 2003

Related U.S. Application Data
(60) Provisional application No. 60/374,349, filed on Apr. 22, 2002.

(51) Int. Cl. G01N 21/64

(52) U.S. Cl. 250/302; 250/459.1; 250/461.1

(57) ABSTRACT

A system for routinely monitoring germ contamination in areas where human interaction takes place, and a method for using the same. A germ detection agent is placed either onto a roll of toilet paper or inside a pair of gloves. After handling the toilet paper, or removing the gloves, the detection agent will be present on the individual's hands. This individual is then directed by proper personal hygiene and health codes to wash his or her hands with soap and water, and then place the hands under an ultraviolet light source in order to visualize any germ detection agent still remaining on the hands. If no detection agent is seen, the individual has been properly sanitized of contamination. If, however, detection agent is still visualized on the hands after washing, then that individual must repeat the hand washing, this time more thoroughly to completely remove remaining germ detection agent, before entering an area where contamination may be spread. The hands of the individual may alternatively be inspected by another, to confirm that no germ detection agent remains.

This claims the benefit of U.S. Provisional Patent Application Serial No. 60/374,349, filed Apr. 22, 2002, and hereby incorporated by reference entirely.

### FIELD OF THE INVENTION

The present invention relates generally to maintaining proper personal hygiene and is particularly directed to a system and method for ensuring adequate hand washing in the work place.

### BACKGROUND OF THE INVENTION

The nature of human beings and the manner in which they interrelate can frequently cause transmission of contagious disease and illness by hand. Pathogens such as salmonella, e. coli, hepatitis virus, and rotavirus travel a fecal-oral route. A tiny amount of a secretion from an infected person (such as feces) finds its way to the mouth of someone else. Therefore, a high degree of cleanliness is necessary in certain environments, where the spread of germs and pathogens can be catastrophic, or even fatal. This is especially true for public service employees, such as those who work in restaurants, hospitality venues, and hospitals. Frequently, a single individual can be responsible for contaminating an entire work area or even an entire facility. Such a person most likely has improperly washed their hands, and is also likely to be unaware that they are the source of contamination.

In actual food borne illness outbreaks, the scenario may go like this: An employee is exposed to a pathogen such as Hepatitis A virus, but doesn't know it. The employee is not proficient at hand washing and personal hygiene. The employee prepares food, leaving the virus in everything he touches, including juices, milk products, vegetables, salads, shellfish, and iced drinks. People eat the food and become ill. The employee has not intentionally caused the illness, but may nevertheless be involved in spreading it. It can therefore be appreciated why food service workers must wash their hands after using the restroom or handling contaminated products, and why pathogens can spread very quickly through a hospital or day care center. Proper hand washing procedures need to be taken in such public service facilities to minimize the transfer of disease-causing pathogens.

Hand washing techniques are known which disclose how to wash hands properly. U.S. Pat. No. 5,900,067, hereby incorporated by reference, discloses the use of a hand washing medium which permits the user to determine the effectiveness of his or her hand washing technique. The technique involves the steps of adding a known phosphorescent detection agent, such as Glo Germ™ powder, to a hand washing medium, applying the hand washing medium to a person's hands, moving the person's hands in contact with each other, washing the hands and thereafter rinsing both hands in water so as to remove the hand washing medium as well as the detection agent. The person's hands are then viewed in reduced or special light for determining the presence of any of the detection agent on the hands, which indicate an unwashed portion thereof.

While such a hand washing technique and analysis teaches one how to properly clean the hands of the detection agent, there is no current method available that reliably enables and ensures that employees of a restaurant or medical facility will use this technique on a routine basis. This invention addresses such problems by providing a system and method for routinely monitoring and encouraging proper procedures and personal hygiene behavior to avoid germ contamination at the work place.

### SUMMARY OF THE INVENTION

Accordingly, an object of this invention is to provide a system and method for tracking germ contamination in a convenient location at the work place, such as in a restroom. Another object of the invention is to reliably deposit a detection agent onto the hands of an employee, for use in tracking germ contamination at the work place. Another object of this invention is to provide public service employees with a system and method to detect and sanitize themselves of contamination before returning to their work station.

One aspect of this invention is a detection agent, such as a non-toxic powder that can be detected by ultraviolet light, which is placed onto an article such as a roll of toilet paper. The toilet paper can be either a conventional roll of toilet paper, to which the germ detection agent is added or dispensed onto just prior to use, or it can be toilet paper manufactured so that the detection agent has already been added during production and/or before packaging. When the toilet paper, with the germ detection agent, is placed in the restroom, an individual taking a rest room break at work, generally an employee of a restaurant or hospital, must come into contact with the germ detection agent while using the toilet.

Toilet paper, commonly used to clean the rectum after having a bowel movement, according to this invention, is advantageously coated with the germ detection agent because of its close association with germ contact. Since the process of using toilet paper deals with the handling of human feces, it is easy for an individual's fingers, finger tips and hands to become contaminated from the feces. Failure to properly clean the contaminated hands, such as by washing with soap and water, can easily result in the transfer of germs, bacteria, viruses and contamination. This problem, as noted above, is especially important with respect to individuals involved in public service, such as restaurants, food service, hospitality and health care.

After using the toilet paper with the detection agent, the individual's hands will invariably be exposed to the detection agent as well. This individual is then directed by proper personal hygiene and health codes to wash his hands with soap and water in a sink in a restroom. Located in a convenient location next to the sink will be a means for the individual to visualize the germ detection agent. This is generally provided by an ultraviolet light source, which is placed next to or in association with the paper towel dispenser. The individual, having washed his hands but prior to drying them, can place his hands under the ultraviolet light source in order to visualize any detection agent still remaining on the hands. If no detection agent is seen, the individual simply dries his hands and exits the restroom, secure in the knowledge that he has adequately prevented the spread of contamination. If, however, detection agent is still present on the hands after washing, then that individual must repeat the washing of his hands, this time more thoroughly, in order to completely remove any remaining germ detection agent.

In accordance with another aspect of the invention, the detection agent can be placed inside gloves, such as rubber, latex, disposable or other types of gloves. Gloves are commonly used by restaurant kitchen and other workers. Before the worker retires to the restroom, she will commonly remove the rubber gloves. The inside of these gloves will have the detection agent. The employee, now with detection agent present on her hands, will use the restroom facilities. Using an ultraviolet light system similar to that described above, the detection agent can be detected and completely washed from the hands prior to returning to work. Once the employee returns to work, where her hands may be inspected by another to confirm that no germ detection agent remains, she can then place a new pair of gloves back on her hands and go back to her work station. Adding the detection agent to the rubber gloves therefore has a similar function as toilet paper with the detection agent. In either manner, the public service employee will be able to visualize germ detection agent on the hands, such that the hands must be thoroughly sanitized prior to returning to work.

This invention in each of its embodiments provides a mechanism to assist, monitor, enforce and encourage proper personal hygiene through a behavioral change with respect to adequate and complete hand washing techniques. While actual bacterial and viral detection is not contemplated by this invention, the system and method of this invention duplicates potential contamination on one's hands as a result of activities such as wiping rectal areas, handling contaminated products such as raw foods or other unsanitary activities.

### BRIEF DESCRIPTION OF THE DRAWINGS

The accompanying drawings, which are incorporated herein and constitute a part of this specification, illustrate embodiments of the invention and, together with the general summary of the invention given above, and a detailed description of the invention given below, serve to explain the principals of the invention.

FIG. 1 is a simplified illustration of a bathroom stall showing a dispenser of detection agent powder located above a toilet paper dispenser;

FIG. 2 is a simplified illustration showing detection agent being visualized under ultraviolet light;

FIG. 3 is a simplified illustration of an individual impregnating rubber gloves with a detection agent;

FIG. 4 is a simplified illustration of a cleaning area of a restroom showing an ultraviolet light source located next to a paper towel dispenser;

FIG. 5 is a simplified illustration showing an individual washing his hands; and

FIG. 6 is a simplified illustration of an individual's hands showing some residual detection agent after initial cleaning.

### DETAILED DESCRIPTION

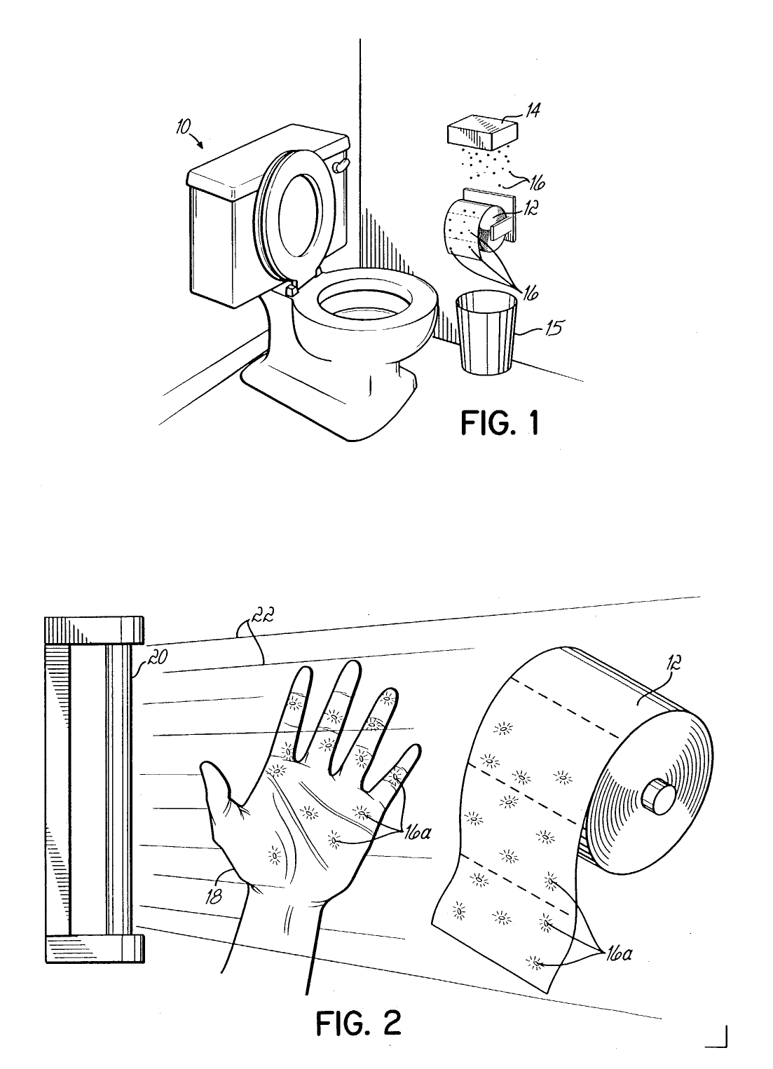

FIG. 1 shows a typical restroom stall, one which would generally be located in a public service facility such as at a restaurant or in a hospital. However, in addition to having a toilet 10 and toilet paper 12, this stall has an additional powder dispenser 14 located above the toilet paper 12. This powder dispenser 14 is used for dispensing a germ detection agent 16, and can be configured to apply this germ detection agent 16 to the toilet paper 12. Preferably, the agent may be Glo Germ™ (www.GLOGERM.com), the composition disclosed in U.S. Pat. No. 3,640,889, hereby incorporated by reference, or another suitable agent. The detection agent 16 replicates a contaminant which is invisible to the naked eye. A waste basket 15 or other receptacle is used to catch any detection agent 16 that bypasses or falls off of the toilet paper 12. Alternatively, the dispenser 14 and/or receptacle 15 may be incorporated into the toilet paper dispensing unit. With this system, when an individual uses the toilet 10 for a bowel movement or micturition, the dispenser 14 generally will be activated or otherwise caused to sprinkle the powder of germ detection agent 16 onto the toilet paper 12 just before it is handled by the individual. Alternatively, the toilet paper 12 may be manufactured with the agent 16 applied thereto, impregnated therein, or otherwise added to the standard toilet paper. Upon handling the toilet paper 12, the individual's hands will have the detection agent 16 transferred onto them.

FIG. 2 shows germ detection agent 16a being caused to glow or otherwise be visualized on both an individual's hand 18 and on toilet paper 12 after placement under an ultraviolet light source 20. Ultraviolet light 22 can be seen coming from the light source 20 and shining on the hand 18 and the toilet paper 12. The germ detection agent 16a can be seen to glow, or fluoresce, when placed under the light 22. As noted above, an individual's hands are covered with the detection agent 16a when toilet paper 12, which has been coated with the detection agent 16a, is handled following a bowel movement or micturition. FIG. 2 is intended to show what the user's hands will look like after using the toilet paper 12 but prior to washing them. When the individual views her hands under the ultraviolet light source 20, the germ detection agent 16a is readily visible in the form of fluorescent or glowing deposits. This invention does not per se detect the contaminant, but the detection agent 16 or 16a is detected on the user's hands and by association the agent 16, 16a must be washed from the hands just as the invisible contaminant would need to be.

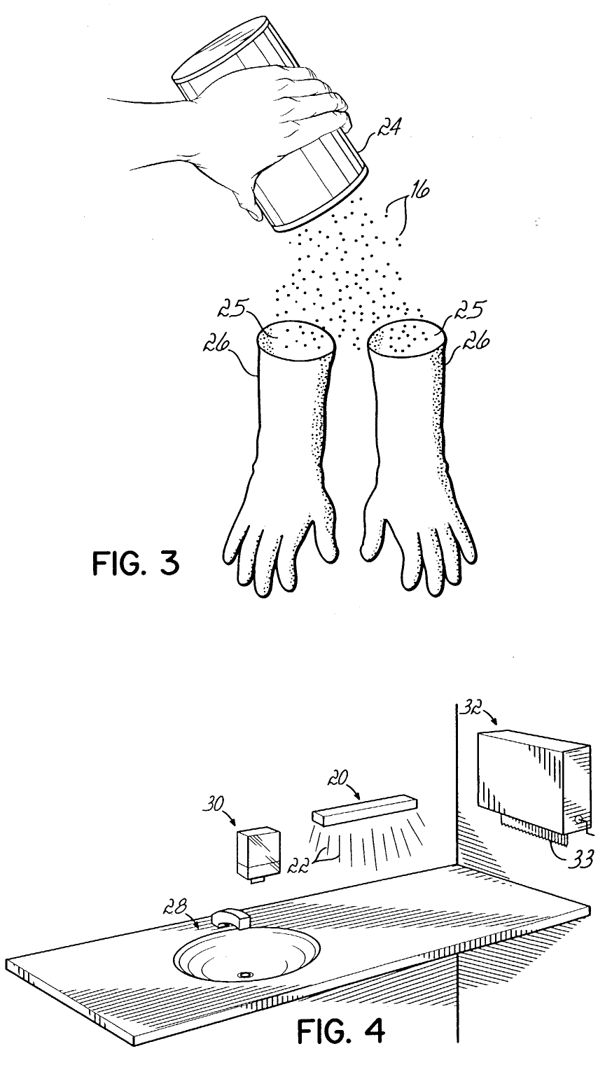

While toilet paper 14 with the agent 16 is a convenient and useful way of transferring germ detection agent onto the hands of an individual, the use of other articles with the detection agent can be equally or even more useful, in certain situations. Referring to FIG. 3, an individual is shown holding a cylindrical powder dispenser 24, sprinkling the detection agent 16 onto the inside surface 25 of a pair of rubber gloves 26. When the inside surface 25 of these rubber gloves 26 are impregnated, coated, dusted, or the like in such a manner, the powder, such as standard talcum or baby powder, containing the detection agent 16 will contact the individual's hands. Therefore, the agent 16 will be transferred to the individual's hands when the rubber or other gloves 26 are worn at the work station. This individual can be, for example, a kitchen worker, nurse, hospital technician or the like who uses the rubber gloves 26 in her general routine work responsibilities. The worker, having detection agent 16 present on her hands, must remove the rubber gloves 26 before leaving to use the restroom facilities.

One advantage of the rubber glove method of transferring detection agent 16 onto the hands, over the toilet paper method, is that the individual may take a break from work but not use the toilet. Pathogens, such as those described herein above, can be present in areas other than the employee's feces, and indeed may be present on surfaces of the work place or rest room facilities. Therefore, it may be desirable to coat the employee's hands with detection agent 16 in some way other than via toilet paper 12. Alternatively, multiple methods of applying the detection agent 16 to the worker's hands can be used simultaneously such as the glove method of transferring the detection agent 16 in combination with the toilet paper method.

After using the restroom facilities or otherwise taking a break from work, but before returning to work, the employee will need to wash her hands. FIG. 4 shows a typical cleaning area found in a restroom of a restaurant or medical facility. However, in addition, there is an ultraviolet light source 20 conveniently located in close proximity to the normal facilities of a sink 28, soap 30, and a paper towel dispenser 32 for paper towels 33. The light source 20 may be incorporated into the dispenser 32 or other equipment. With this configuration, an individual, who has transferred germ detection agent 16 onto her hands after either using the toilet paper 12 of FIG. 1 or the rubber gloves 26 of FIG. 3, will use the cleaning area of FIG. 4 to wash her hands. After washing, she will then check to see if her hand washing technique was adequate to remove all traces of the germ detection agent (not shown). Proper hand washing technique will be more fully illustrated below. After washing her hands with soap 30, but before drying them with the paper towel 33, the individual will view her hands under the ultraviolet light 22 emitted from the light source 20. The ultraviolet light 22 will allow visualization of any detection agent (not shown) still remaining on the hands. If detection agent is not visualized, then the individual will simply dry her hands, having properly sanitized her hands before going back to work. Alternatively, a co-worker or supervisor can inspect the employee's hands.

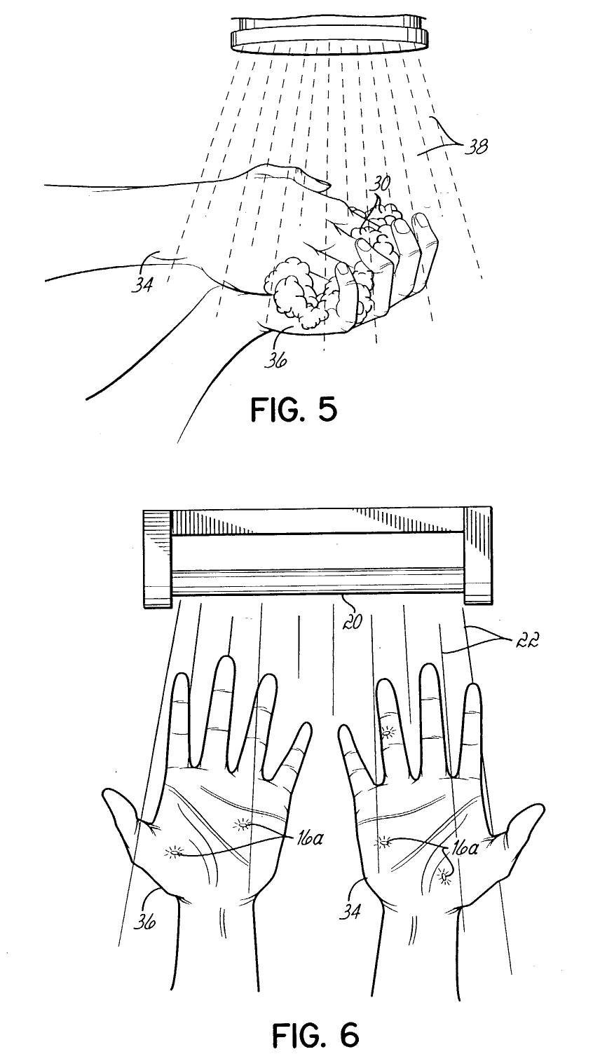

FIG. 5 shows an individual's right and left hands 34, 36 engaging in the act of washing with a cleansing agent such as soap 30. The germ detection agent, at least in part, and the cleansing agent 30 are then rinsed from the hands 34, 36 by means of a stream of water 38. In accordance with one aspect of the present invention, the function of a proper hand washing technique is to thoroughly sanitize the hands 34, 36 from pathogens, germs or other contamination after exposure to fecal material. The water 38 rinses the hands, hopefully removing all traces of the germ detection agent 16 as well as any other contaminants.

FIG. 6 shows the right and left hands 34, 36 of FIG. 5, in which areas of the fluorescent detection agent 16a remain where the hand washing process was inadequate. These remaining fluorescent deposits of detection agent 16a are visualized when the hands 34, 36 are placed under the ultraviolet light 22 coming from the light source 20, and indicate those portions of the hands 34, 36 which have not been cleaned properly. The hands of this particular individual illustrated in FIG. 6 must be washed again, this time altering the hand washing technique in order to expose all surface portions of the hands 34, 36 to soap 30 and water 38 for a more effective cleaning. After the hands 34, 36 are washed a second time, they are again reviewed under ultraviolet light 22 to determine if detection agent 16a still remains. If so, this process of hand washing, rinsing, and detection is continued until no further fluorescence can be visualized. When the individual's hands 34, 36 no longer show the presence of any detection agent 16a, that individual can return to work, secure in the knowledge that she has properly cleaned and decontaminated her hands before going back to work. As noted above, alternatively, a co-worker or supervisor can inspect the employee's hands before the employee is permitted back to work.

In an alternative aspect of this invention, the detection agent 16, 16a could be periodically replaced with a placebo agent, powder or the like. The placebo agent preferably has the same physical appearance, feel, aroma and the like as the detection agent 16 so that the individual would not be able to detect that the agent 16 has been replaced with the placebo. The placebo would not necessarily fluoresce when exposed to the light source 20, but would be more economical to use than the detection agent 16. As such, after a hygiene regime utilizing this invention and the detection agent 16 has been implemented and the employees have established a proper hand washing routine, the restaurant, health care facility, employer or the like could periodically replace the agent 16 with the more economical placebo without alerting the employees. Consequently, the employees will continue the established and acceptable hygiene regimen not knowing that the powder on their hands is the placebo. The detection agent 16 could be periodically utilized thereafter to re-evaluate and/or reinforce the proper hand wash practices according to this invention.

While the present invention has been illustrated by the description of various embodiments, and while these embodiments have been described in detail, it is not the intention of the applicants to restrict or in any way limit the scope of the appended claims to such detail. Indeed, additional advantages and modifications will be readily apparent to those skilled in the art. The invention in its broader aspect is therefore not limited to the specific details, representative figures, and descriptions. Accordingly, departures may be made from such details without departing from the spirit or scope of the applicants' general inventive concept.

What is claimed is:

1. A method for monitoring personal hygiene practices comprising the steps of:
applying a detection agent to a user's hands prior to the user washing the hands;
washing the user's hands to remove at least some of the detection agent, wherein the washing includes applying a cleansing agent to the user's hands;
detecting any of the detection agent remaining on the user's hands after the washing;
re-washing the user's hands if any of the detection agent remains on the user's hands after the washing; and
assessing if substantially all of the detection agent has been removed from the user's hands thereby indicating that the user's hands have been cleansed.

2. The method of claim 1 wherein the applying of the detection agent further comprises applying the detection agent to toilet paper to be used by the user.

3. The method of claim 2 wherein the applying of the detection agent is accomplished by at least one of the following techniques: impregnating the toilet paper with the detection agent and sprinkling the toilet paper with the detection agent prior to use.

4. The method of claim 1 wherein the applying of the detection agent further comprises:
wearing gloves by the user in which the gloves have the detection agent applied thereto and the detection agent is transferred from the gloves to the user's hands.

5. The method of claim 1 wherein the detecting further comprises:
illuminating the user's hands to expose the detection agent, if any, remaining on the hands.

6. The method of claim 5 wherein the user's hands are illuminated with an ultra-violet light to allow the detection agent to fluoresce.

7. A method for monitoring personal hygiene practices comprising the steps of:
applying a detection agent to a user's hands;
washing the user's hands to remove at least some of the detection agent;
detecting any of the detection agent remaining on the user's hands after the washing;
re-washing the user's hands if any of the detection agent remains on the user's hands after the washing;
assessing if substantially all of the detection agent has been removed from the user's hands thereby indicating that the user's hands have been cleansed;
selectively applying a placebo agent to the user's hands.

8. The method of claim 7 in which the placebo agent is substantially indistinguishable by the user from the detection agent prior to the detecting step.

9. The method of claim 7 wherein the applying of the detection agent and the selectively applying of the placebo agent each further comprise applying the respective agent to toilet paper to be used by the user.

10. The method of claim 9 wherein the applying of the detection agent and the selectively applying of the placebo agent are each accomplished by at least one of the following techniques: impregnating the toilet paper with the respective agent and sprinkling the toilet paper with the respective agent prior to use.

11. The method of claim 7 wherein the applying of the detection agent and the selectively applying of the placebo agent each further comprise:
wearing gloves by the user in which the gloves have the respective agent applied thereto and the respective agent is transferred from the gloves to the user's hands.

12. The method of claim 7 wherein the detecting further comprises:
illuminating the user's hands to expose the detection agent, if any, remaining on the hands.

13. The method of claim 12 wherein the user's hands are illuminated with an ultra-violet light to allow the detection agent to fluoresce.

14. The method of claim 7 wherein the washing and re-washing each include a cleansing agent.

15. A system for monitoring personal hygiene practices comprising:
a detection agent adapted to be applied to a user's hands prior to the user washing their hands;
a hand washing facility including a cleansing agent for washing the user's hands and removing at least part of the detection agent applied to the hands;
a detection mechanism adapted to detect any of the detection agent remaining on the user's hands.

16. The system of claim 15 further comprising:
an application medium adapted to apply the detection agent to the user's hands.

17. The system of claim 16 wherein the application medium is selected from at least one of the following: gloves adapted to worn by the user and toilet paper.

18. The system of claim 15 further comprising:
a detection agent dispenser.

19. The system of claim 18 further comprising:
a toilet paper dispenser;
wherein the detection agent dispenser is positioned proximate the toilet paper dispenser to thereby dispense the detection agent onto a supply of toilet paper prior to being dispensed.

20. The system of claim 15 wherein the detection mechanism is an ultra-violet light source and the detection agent fluoresces when illuminated by ultra-violet light.

21. The system of claim 15 further comprising:
a placebo agent adapted to be selectively applied to the user's hands, the placebo agent being substantially indistinguishable from the detection agent in the absence of the detection mechanism.

22. A combination comprising:
a supply of toilet paper; and
a detection agent adapted to be transferred to a user's hands and washed therefrom;
wherein the detection agent indicates an area of the user's hands, if any, that was not removed from the hands during the washing.

23. The combination of claim 22 wherein the detection agent is adapted to fluoresce when exposed to ultra-violet light.

24. The combination of claim 22 wherein the toilet paper is impregnated with the detection agent.

25. A combination comprising:
a glove; and
a detection agent adapted to be transferred to a user's hands and washed therefrom;
wherein the detection agent indicates an area of the user's hands, if any, that was not removed from the hands during the washing.

26. The combination of claim 22 wherein the detection agent is adapted to fluoresce when exposed to ultra-violet light.

27. The combination of claim 22 wherein an interior surface of the glove is substantially coated with the detection agent.
